(19) United States
(12) Patent Application Publication
(10) Pub. No.: US 2018/0072103 A1
(43) Pub. Date: Mar. 15, 2018

(54) Tread Layer For A Tire Comprising Channels

(71) Applicant: COMPAGNIE GENERALE DES ETABLISSEMENTS MICHELIN, Clermont-Ferrand (FR)

(72) Inventors: Marie-Hélène VANTAL, Clermont-Ferrand Cedex 9 (FR); Vincent LEDIEU, Clermont-Ferrand Cedex 9 (FR); Kazutaka YOKOKAWA, Clermont-Ferrand Cedex 9 (FR); Quentin BONNETON, Clermont-Ferrand Cedex 9 (FR); Héloïse DEBORDEAUX, Clermont-Ferrand Cedex 9 (FR); Mathieu VANDAELE, Clermont-Ferrand Cedex 9 (FR)

(21) Appl. No.: 15/559,232

(22) PCT Filed: Mar. 24, 2016
(86) PCT No.: PCT/FR2016/050656

§ 371 Date: Sep. 18, 2017

(30) Foreign Application Priority Data
Mar. 31, 2015 (FR) 1552752

(51) Int. Cl. B60C 11/12; B60C 11/13; B60C 11/03

(52) U.S. Cl. CPC B60C 11/1204; B60C 11/1236; B60C 11/0302; B60C 11/1323

(57) ABSTRACT

A tire comprising a tread. This tread comprises at least one elongate block delimited by at least one lateral wall (5) and a contact face (7). The lateral wall (5) makes a non-zero angle with a transverse direction and the contact face contacts a road surface. The tire comprises at least one channel (19) extending through the elongate block and leading onto the lateral wall (5) of this elongate block. The tire also comprises a sipe extending from the channel towards the contact face, this sipe leading onto the lateral wall of the elongate block in a lateral wall outlet region. The lateral wall of the elongate block is inclined with respect to a radial direction (Z), at least in the lateral wall outlet region of the sipe, at an angle θ of between 20 degrees and 60 degrees with respect to this radial direction (Z).

### FIELD OF THE INVENTION

The present invention relates to a tire comprising a tread. More particularly, the invention relates to a tread comprising a plurality of channels which are not visible when the tread is in a new state.

### PRIOR ART

The document EP2332745 discloses a directional tire comprising a plurality of circumferential or oblique grooves that delimit elongate blocks of rubber. All or some of these elongate blocks of rubber comprise channels at a depth therein. These channels appear starting from a certain degree of tread wear and are intended to increase the groove density of this tread starting from this particular degree of wear. Specifically, in the new state, the visible grooves evacuate water, notably, when rolling over a wet road. The volume of water that the tread is capable of evacuating is directly linked to the depth of these visible grooves. With wear, the depth of the visible grooves decreases, and thus the evacuation capacity of the tread also decreases. As a result of the tread being given new recesses via the concealed channels, a certain capacity of the tire to evacuate water even in an advanced state of wear is thus maintained.

FIG. 6 of the document EP2332745 presents a cross-sectional view of an elongate block. In this cross-sectional view, the elongate block comprises a channel and a sipe extending this channel as far as a contact face of the elongate block. More particularly, the channel has a transitional part in which the width of the channel decreases. FIG. 4 of the document EP2332745 presents the line of the channel and of the sipe on a lateral wall of an elongate block. On cornering, and particularly at the limits of grip, the tire is highly stressed in a transverse direction. It is the lateral walls of the elongate blocks that take up all or some of these stresses, these lateral walls extending mainly in the circumferential direction. However, the elongate block exhibits a degree of fragility around the transitional part of the channel and around the sipe. The channel and the sipe lead onto the lateral wall of the elongate block, and so there is a risk of the rubber in the elongate block tearing around the channel and the sipe. This risk is increased further in that FIG. 4 discloses serrations on the contact face of the elongate block, these serrations affording regions of increased stresses for stones in relative movement with respect to the tread.

Therefore, there is a need to propose a tire that has good grip characteristics on a wet road both in the new state and in a partially worn state, while exhibiting good mechanical strength with respect to the stresses exerted on the tread thereof.

### Definitions

A “tire” means all types of resilient tread, whether or not it is subjected to an internal pressure.

A “rubber material” means a diene elastomer, that is to say, in a known way, an elastomer which is based, at least partially (i.e. is a homopolymer or a copolymer), on diene monomers (monomers bearing two conjugated or non-conjugated carbon-carbon double bonds).

The “tread” of a tire means a quantity of rubber material delimited by lateral surfaces and by two main surfaces, one of which, referred to as the tread surface, is intended to come into contact with a road surface when the tire is being driven on.

A “block” means a raised element formed on the tread, said element being delimited by voids or grooves and comprising lateral walls and a contact face.

A “groove” means a cutout, the material faces of which do not touch under normal rolling conditions. Generally, the width of a groove is greater than or equal to 2 mm.

A “sipe” means a cutout that delimits two lateral walls of two adjacent blocks, said lateral walls touching under normal rolling conditions. Generally, the width of a sipe is less than 2 mm.

The “lateral wall outlet region of the sipe” means a region centred on a line formed by the sipe on this lateral wall. The width of this region is at least twice the width of the sipe.

The “contact face outlet region of the sipe” means a region centred on a line formed by the sipe on this contact face. The width of this region is at least twice the width of the sipe.

A radial direction means a direction which is perpendicular to the axis of rotation of the tire (this direction corresponds to the direction of the thickness of the tread).

A transverse or axial direction means a direction parallel to the axis of rotation of the tire.

A circumferential direction means a direction tangential to any circle centred on the axis of rotation of the tire. This direction is perpendicular both to the axial direction and to a radial direction.

### SUMMARY OF THE INVENTION

The invention relates to a tire comprising a tread. This tread comprises at least one elongate block. The elongate block is delimited by at least one lateral wall and a contact face. The lateral wall makes a non-zero angle with a transverse direction and the contact face is intended to come into contact with a road surface. The tire comprises at least one channel that extends through the elongate block and leads onto the lateral wall of this elongate block. The tire also comprises a sipe extending from the channel towards the contact face, this sipe leading onto the lateral wall of the elongate block in a lateral wall outlet region. The lateral wall of the elongate block is inclined with respect to a radial direction, at least in the lateral wall outlet region of the sipe, at an angle θ of between 20 degrees and 60 degrees with respect to this radial direction.

During rolling, the tread of the tire is mechanically stressed by stones present on the road surface. Each stone causes a local deformation of the tread in the contact region between the stone and this tread. This local deformation can lead to cracks in the rubber which, by spreading, result in parts of the rubber of the tread tearing. This phenomenon is accentuated by the presence of sipes and channels that lead into lateral walls of elongate blocks. Specifically, when the lateral walls make a non-zero angle with a transverse direction, the lateral walls are subjected to the mechanical stresses of these stones, notably during cornering and at the limits of grip. By providing a specific inclination, greater than 20 degrees in the outlet region of the lateral wall, the stones “slide” more easily over the lateral wall, reducing the risk of the creation of cracks in the block of rubber. The area of the contact face is directly linked to the inclination angle of the lateral wall. The greater the inclination angle, the more the area of the contact face of the block decreases. By limiting the inclination angle to 60°, a sufficient area of the contact face is thus maintained to ensure good grip of the tire on the road surface, notably during braking and/or acceleration operations in a straight line.

In one variant embodiment, the elongate block is part of a set of blocks. The set of blocks extends from one edge of the tread towards the centre of this tread, generally along a curvature C. The set of blocks is repeated around the entire circumference of the tire such that the tread is directional, at least in part. The elongate block is separated from another block of the set of blocks by a groove, this groove delimiting the inclined lateral wall of the elongate block into which the sipe and the channel lead.

In this configuration, the lateral wall of the block is at least partially protected by another block of the set of blocks. In the event of significant lateral stresses, of the slipping type, these stresses are taken up by all the blocks of the set of blocks. The groove delimiting the inclined lateral wall is a secondary groove with respect to a main groove delimiting the set of blocks. By providing that the channel leads into this secondary groove instead of the main groove, a situation in which the water evacuated by the channel disrupts the evacuation of the water in the main groove too much is avoided. This promotes the grip of the tire on a wet road surface, notably when the tread is in an advanced state of wear.

In one variant embodiment, the sipe leads onto the contact face in a contact face outlet region of the sipe. The contact face outlet region of the sipe comprises a texture that contrasts with the rest of the contact face, this texture being produced integrally with the elongate block.

In this way, the presence of concealed channels in the tread is identified more easily when the latter is in a new state. Specifically, the presence of such a channel can be an additional argument for selling the tire. A “texture that contrasts with the rest of the contact face” means that the difference in lightness between the texture on the contact face and the rest of the contact face is at least 5 units. “Lightness”, also referred to as “luminance”, means the parameter which characterizes a surface to reflect light to a greater or lesser extent. Lightness is expressed using a scale that ranges from 0 to 100 according to the L*a*b* colour model established by the CIE (International Commission on Illumination) in 1976. The value 100 represents white or total reflection; the value 0 represents black or total absorption. In this case, the lightness of the texture is considered to be between 5 and 18, preferably between 8 and 16, and the lightness of the rest of the contact face is considered to be between 20 and 35.

Preferably, the texture comprises a plurality of strands distributed through the texture at a density at least equal to one strand per square millimetre (mm²), each strand having a mean cross section of between 0.003 mm² and 1 mm².

A texture that contrasts with the rest of the contact face is thus obtained in a simple and practical manner.

In one variant embodiment, the texture comprises a plurality of lamellae having a spacing of less than 0.3 mm and a mean width of between 0.03 mm and 0.25 mm.

A texture that contrasts with the rest of the contact face is likewise obtained in a simple and practical manner.

In a preferred embodiment, the sipe forms a line on the contact face of the elongate block, the lamellae of the texture extending generally parallel to this line.

In this way, the creation of regions on the contact surface that make it easier for stones to be wedged with respect to the block, in the relative movement of these stones with respect to the tread, is avoided.

### BRIEF DESCRIPTION OF THE DRAWINGS

Other features and advantages of the invention will become apparent from the following description, given by way of non-limiting example, with reference to the attached drawings in which:

FIG. 1 shows a partial view of a tread of a tire according to the invention;

FIG. 2 schematically shows a view in cross section of an elongate block of the tread from FIG. 1;

FIG. 3 is an enlarged view of an elongate block of the tread from FIG. 1;

FIG. 4 shows an enlarged view of an elongate block of the tread from FIG. 1, comprising a texture;

FIG. 5 describes a texture present on the elongate block from FIG. 3, according to a first embodiment;

FIG. 6 describes a texture present on the elongate block from FIG. 3, according to a second embodiment.

In the following description, elements which are substantially identical or similar will be denoted by identical references.

FIG. 1 shows a partial view of a tread of a tire. This tread comprises at least one elongate block 3 extending in a main direction U. This main direction U makes a non-zero angle with a transverse direction Y. In a preferred embodiment, the main direction of the elongate block is between 45 degrees and 80 degrees with respect to the transverse direction Y. The elongate block 3 comprises a sipe 11 that leads onto a contact face 7 of the elongate block, forming a line which is rectilinear in this case. The elongate block 3 also comprises a channel 9 disposed at a depth in the block, the sipe 11 connecting the channel 9 to the contact face 7 of the block. The channel 9 and the sipe 11 lead onto a lateral wall 5 of the elongate block 3.

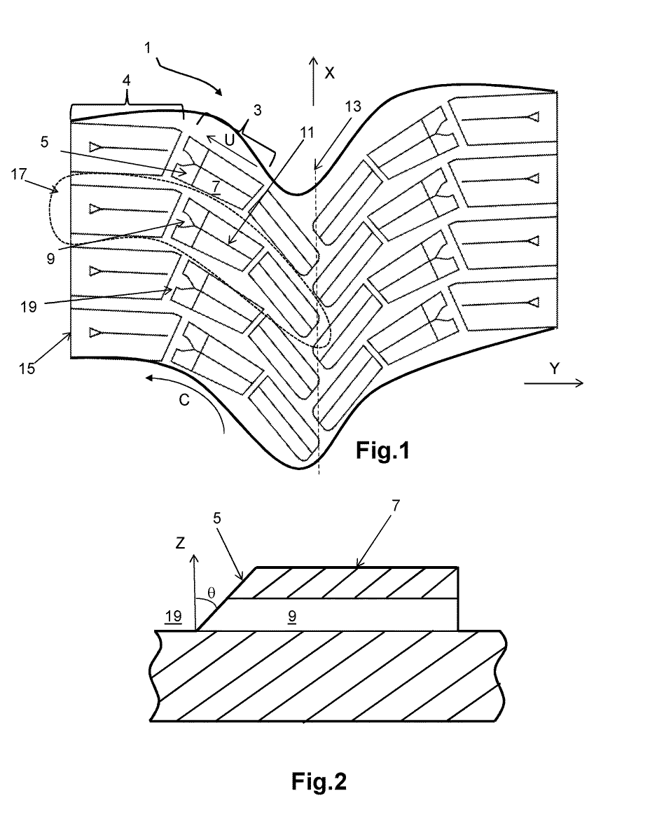

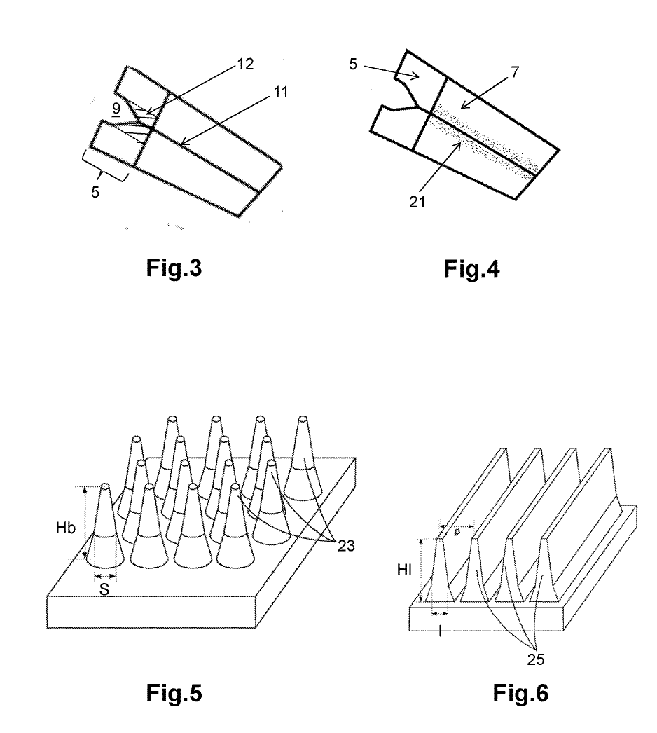

As can be seen in FIG. 2, the lateral wall 5 of the elongate block 3 is inclined with respect to a radial direction Z by an angle θ of between 20 degrees and 60 degrees with respect to this radial direction Z. In other words, with the angle θ, the groove 19 bordering the lateral wall 5 widens from the bottom of the groove 19 towards the surface of the tread. The inclination of the lateral wall 5 makes it easier to evacuate stones that act on this lateral wall, notably during a transverse movement of these stones with respect to the elongate block 3. In this way, the stresses generated by the stones on this lateral wall 5 are limited, notably in the rubber part present above the outlet of the channel 9 on the lateral wall 5 close to the sipe 11 (hatched part 12 in FIG. 3).

It will be noted that, in FIGS. 1 to 3, it is the entire lateral wall 5 of the elongate block 3 that is shown as being inclined. Alternatively, only a region of the lateral wall 5 is inclined, this region being centred on the sipe 11 and the width of this region being at least twice the width of the sipe 11.

It will also be noted that the channel 9 and the sipe 11 lead onto a lateral wall which extends generally in a manner perpendicular to the main direction of extension U of the elongate block 3. Alternatively, the channel and the sipe can lead onto a lateral wall parallel to this main direction of extension U.

Finally, it will be noted that, in FIG. 1, the elongate block 3 is part of a set of blocks 17 comprising in this case three blocks. The set of blocks 17 extends from one edge 15 of the tread towards a centre 13 of this tread, generally along a curvature C. The blocks of the set of blocks 17 widen from the centre 13 towards the edge 15. The set of blocks is in this case repeated on each side of the centre 13 of the tread and around the entire circumference of the tire, such that the tread is directional. A “directional tread” means a tread that has a preferred rolling sense such that, when the tire is rotated in this preferred sense, the latter affords properties of grip on the ground that are better than those afforded when the tire is rotated in the other sense.

In FIG. 1, the elongate block 3 is separated from another block 4 of the set of blocks 17 by the groove 19. As has already been specified, the groove 19 delimits the inclined lateral wall 5 of the elongate block 3 into which the sipe 11 and the channel 9 lead.

FIG. 4 shows an enlarged view of the elongate block 3 of the tread. This block 3 comprises a contact face 7 onto which the sipe 11 leads. The block 3 also comprises a texture 21 produced integrally with the contact face 7 and contrasting with the rest of the contact face 7. This texture surrounds the outlet of the sipe 11 on the contact face 7 in a region that is centred on the sipe and has a width at least twice the width of the sipe. A “texture” means an organized arrangement of a plurality of elements, all or some of the elements in the arrangement being the repetition of one and the same basic element, for example a strand or a lamella.

A “strand” means a filiform element, the height of which is at least equal to twice the diameter of a disc having the same surface area as the mean cross section of the strand. The texture involving strands 23 is illustrated in FIG. 5.

“Lamellae” means elongate strands which have a length at least equal to twice their height. The texture involving lamellae 25 is illustrated in FIG. 6.

The effect of these strands or lamellae is to “trap” a large quantity of the incident light rays that strike the texture 21, such that this texture 21 appears to be blacker than the rest of the contact face 7.

In FIG. 5, the strands 23 are distributed in the texture 21 at a density at least equal to one strand per square millimetre (mm²), each strand having a mean cross section S of between 0.003 mm² and 1 mm². It will be noted that the mean cross section of each strand corresponds to the mean of the cross sections S measured at regular intervals from the base of the strand. The strands 6 have a conical overall shape with a cross section that decreases over the height Hb of these strands.

In FIG. 6, the lamellae 25 are substantially parallel to one another. The spacing P of the lamellae in the texture is between 0.1 mm and 0.5 mm Each lamella has a mean width of between 0.03 mm and 0.25 mm. The mean width corresponds in this case to the mean of the widths 1 measured at regular intervals over the height Hl of the lamella, the height of each lamella being between 0.05 mm and 0.5 mm. In a preferred embodiment, the lamellae 25 of the texture 21 extend parallel to the line formed by the sipe 11 on the contact face of the elongate block.

The invention is not limited to the examples described and shown and various modifications can be made thereto without departing from its scope.

Thus, it is possible for the lines formed by the sipe 11 on the contact face 7 of the block or on the inclined lateral wall 5 not to be rectilinear. These lines may, for example, be curved, zigzag-shaped or the like.

Moreover, it is possible for the sipe 11 and the channel 9 not to be aligned but to form a non-zero angle between their respective directions of extension.

1. A tire comprising a tread, said tread comprising at least one elongate block, the elongate block being delimited by at least one lateral wall and a contact face, said lateral wall making a non-zero angle with a transverse direction, said contact face being adapted to come into contact with a road surface, the tire comprising at least one channel that extends through the elongate block and leads onto the lateral wall of this elongate block, the tire comprising a sipe towards the contact face, said sipe leading onto the lateral wall of the elongate block in a lateral wall outlet region, wherein the lateral wall of the elongate block is inclined with respect to a radial direction, at least in the lateral wall outlet region of the sipe, at an angle θ of between 20 degrees and 60 degrees with respect to said radial direction.

2. The tire according to claim 1, the tread comprising a centre and an edge, wherein the elongate block is part of a set of blocks, said set of blocks extending from the edge of the tread towards the centre, generally along a curvature C, said set of blocks being repeated around the entire circumference of the tire such that the tire is directional, at least in part, and wherein the elongate block is separated from another block of the set of blocks by a groove, said groove delimiting the inclined lateral wall of the elongate block into which the sipe and the channel lead.

3. The tire according to claim 1, wherein, with the sipe leading onto the contact face in a contact face outlet region of the sipe, said contact face outlet region of the sipe comprises a texture that contrasts with the rest of the contact face, said texture being produced integrally with the elongate block.

4. The tire according to claim 3, wherein the texture comprises a plurality of strands distributed through the texture at a density at least equal to one strand per square millimetre (mm²), each strand having a mean cross section of between 0.003 mm² and 1 mm².

5. The tire according to claim 3, wherein the texture comprises a plurality of lamellae having a spacing of less than 0.3 mm and a mean width of between 0.03 mm and 0.25 mm.

6. The tire according to claim 5, wherein, with the sipe forming a line on the contact face of the elongate block, the lamellae of the texture extend generally parallel to said line.
